(19) United States
(12) Patent Application Publication
(10) Pub. No.: US 2023/0179605 A1
(43) Pub. Date: Jun. 8, 2023

(54) PROVIDING EQUAL SIGNING AUTHORITY BETWEEN MULTIPLE DEVICES OF A SINGLE USER IN AN END-TO-END ENCRYPTED MESSAGING SYSTEM

(71) Applicant: WhatsApp LLC, Menlo Park, CA (US)

(72) Inventors: Maaz Ali, Redwood City, CA (US); Colin Clemmons, Oakland, CA (US)

(21) Appl. No.: 17/542,316

(22) Filed: Dec. 3, 2021

(51) Int. Cl. H04L 9/08

(52) U.S. Cl. CPC H04L 63/123; H04L 63/065; H04L 9/085; H04L 63/08

(57) ABSTRACT

Methods, systems, and storage media providing equal signing authority between multiple devices of a single user in an end-to-end encrypted messaging system are disclosed. Exemplary implementations may generate an account key comprising a public account key and a private account key for onboarding a first user device of a first user to the end-to-end encrypted messaging system; upload the public account key to an encrypted server of the end-to-end encrypted messaging system; in response to a request to onboard a second user device to the end-to-end encrypted messaging system, establish a secure communication channel between the second user device and the first user device; send a copy of the private account key to the second user device from the first user device through the secure communication channel; and onboard a third user device to the end-to-end encrypted messaging system through either the first user device or the second user device.

### TECHNICAL FIELD

The present disclosure generally relates to user authentication and more particularly to providing equal signing authority between multiple devices of a single user in an end-to-end encrypted messaging system.

### BACKGROUND

With advances in electronic communication, many people use various forms of electronic communication to communicate with other people. In addition, mobile devices (e.g., smart phones, tablets, etc.) have become increasingly popular, and allow people to send and receive electronic communications from almost anywhere. Conventionally, users of messaging applications engage such applications on a primary device. A user may use a username and password combination, sometimes accompanied by a multi-factor authentication step, to log into and authenticate on a device. This authentication allows the user, via their device, to communicate with other users. More and more, individual users engage multiple devices (e.g., smart phone plus one or more tablets, smart watches, laptops, smart displays, and/or other devices) for communication with others. As device use expands, the opportunity for malicious use increases. Ensuring trustworthy authentication is available for and between devices is of growing importance.

### BRIEF SUMMARY

The subject disclosure provides for systems and methods for user authentication. In order to allow for multiple user devices to be used to communicate with others over a communication network, a secure and authenticated system is described. Each user device must have a means to providing trustworthy authentication. In addition, each user device may be used to add (or remove) other/additional user devices onto an account—with equivalent signing authority.

One aspect of the present disclosure relates to a method for providing equal signing authority between multiple devices of a single user in an end-to-end encrypted messaging system. The method may include generating an account key comprising a public account key and a private account key for onboarding a first user device of a first user to the end-to-end encrypted messaging system. The method may include uploading the public account key to an encrypted server of the end-to-end encrypted messaging system. The method may include, in response to a request to onboard a second user device to the end-to-end encrypted messaging system, establishing a secure communication channel between the second user device and the first user device. The method may include sending a copy of the private account key to the second user device from the first user device through the secure communication channel. The method may include onboarding a third user device to the end-to-end encrypted messaging system through either the first user device or the second user device.

Another aspect of the present disclosure relates to a system configured for providing equal signing authority between multiple devices of a single user in an end-to-end encrypted messaging system. The system may include one or more hardware processors configured by machine-readable instructions. The processor(s) may be configured to generate an account key comprising a public account key and a private account key for onboarding a first user device of a first user to the end-to-end encrypted messaging system. The processor(s) may be configured to upload the public account key to an encrypted server of the end-to-end encrypted messaging system. The processor(s) may be configured to, in response to a request to onboard a second user device to the end-to-end encrypted messaging system, establish a secure communication channel between the second user device and the first user device. The processor(s) may be configured to send a copy of the private account key to the second user device from the first user device through the secure communication channel. The processor(s) may be configured to onboard a third user device to the end-to-end encrypted messaging system through either the first user device or the second user device.

Yet another aspect of the present disclosure relates to a non-transient computer-readable storage medium having instructions embodied thereon, the instructions being executable by one or more processors to perform a computer-implemented method for providing equal signing authority between multiple devices of a single user in an end-to-end encrypted messaging system. The method may include generating an account key comprising a public account key and a private account key for onboarding a first user device of a first user to the end-to-end encrypted messaging system. The method may include uploading the public account key to an encrypted server of the end-to-end encrypted messaging system. The method may include, in response to a request to onboard a second user device to the end-to-end encrypted messaging system, establishing a secure communication channel between the second user device and the first user device. The method may include sending a copy of the private account key to the second user device from the first user device through the secure communication channel. The method may include onboarding a third user device to the end-to-end encrypted messaging system through either the first user device or the second user device.

Still another aspect of the present disclosure relates to a system configured for providing equal signing authority between multiple devices of a single user in an end-to-end encrypted messaging system. The system may include means for generating an account key comprising a public account key and a private account key for onboarding a first user device of a first user to the end-to-end encrypted messaging system. The system may include means for uploading the public account key to an encrypted server of the end-to-end encrypted messaging system. The system may include means for, in response to a request to onboard a second user device to the end-to-end encrypted messaging system, establishing a secure communication channel between the second user device and the first user device. The system may include means for sending a copy of the private account key to the second user device from the first user device through the secure communication channel. The system may include means for onboarding a third user device to the end-to-end encrypted messaging system through either the first user device or the second user device.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system configured for adding a new trusted device to an account, according to certain aspects of the disclosure.

FIG. 2 illustrates an example data model for configuring signing authority between multiple user devices, according to certain aspects of the disclosure.

FIG. 3 illustrates a system configured for user authentication, in accordance with one or more implementations.

FIG. 4 illustrates an example flow diagram for user authentication, according to certain aspects of the disclosure.

FIG. 5 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

As users add more devices to their accounts, managing the security and trustworthiness (e.g., protecting against and mitigating compromises) becomes more and more difficult. In cases where a user's phone is their primary means of communication, this “primary” device could be used as a central and trustworthy authentication device. As messaging tools are more and more being used on multiple personal devices, relying on a single “primary” device may not be helpful when the user does not have such a primary device, or when such device changes from time to time.

The subject disclosure provides for systems and methods for user authentication. A user may have multiple devices which are used to communicate with others on a particular platform. Each device can have equal signing authority to authenticate and identify the user. By virtue of this equal status, onboarding of new devices can be done securely by using any other authenticated user device associated with their account on the platform.

Implementations described herein address the aforementioned shortcomings and other shortcomings by allowing the user to configure equal authentication authority across multiple devices. In exemplary implementations, cryptographic keys used to sign user communication and authenticate messaging originating from a given device may be shared among devices in a secure and trustworthy manner. Some implementations may include a method for setting up new devices from a current device as well as removing devices from an account in a manner so as to maintain functionality on active devices while protecting against unauthorized account use.

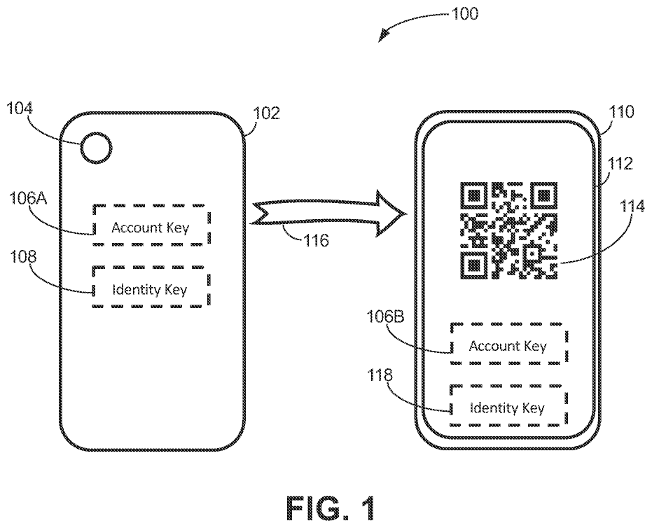

FIG. 1 illustrates a system 100 configured for adding a new trusted device to an account, according to certain aspects of the disclosure. The system 100 may include a first device 102 comprising a camera 104, an account key 106A, and an identity key 108. A second device 110 may be additionally included, the second device 110 comprising a screen 112.

When the first device 102 is added to a user's account on a communication platform, as part of the setup process, the account key 106A and the identity key 108 may be created. The account key 106A may be used to tie the device to the user's communication platform account. The identity key 108 may be used to specifically identify the user's device. When the user wants to add a second device 110 to their communication platform account, the second device may generate its own identity key 118 to identify itself. It can then be associated with the user account by receiving a copy of the account key 106B. A secure method of transferring the account key 106A to the second device 110 may be used. In this way, the second device 110 can communicate on the communication platform in a trustworthy manner (e.g., recipients of communication from the second device can be confident that the communication did indeed originate from the expected user of the first device 102 or second device 110).

In some examples, to initiate a secure communication of the account key 106A from the first device 102 to the second device 110, the second device 110 may generate an encoded message to be fed as an input to the first device 102. In an example, a QR code 114 may be generated on the screen 112 of the second device 110. The user may use the camera 104 of the first device 102 to read the QR code 114. The QR Code 114 may include data sufficient to allow the first device 102 to initiate a secure communication channel 116 with the second device 110. Through the secure communication channel 116, the account key 106A may be communicated to the second device 110 and stored in effect as a copy of the account key 106B. At this point, the second device 110 has equivalent authority in identifying the user account as the first device 102. Because of this authority equivalence, should a third device be desired to add to the user account, either the first device 102 or the second device 110 may be used in the manner just described.

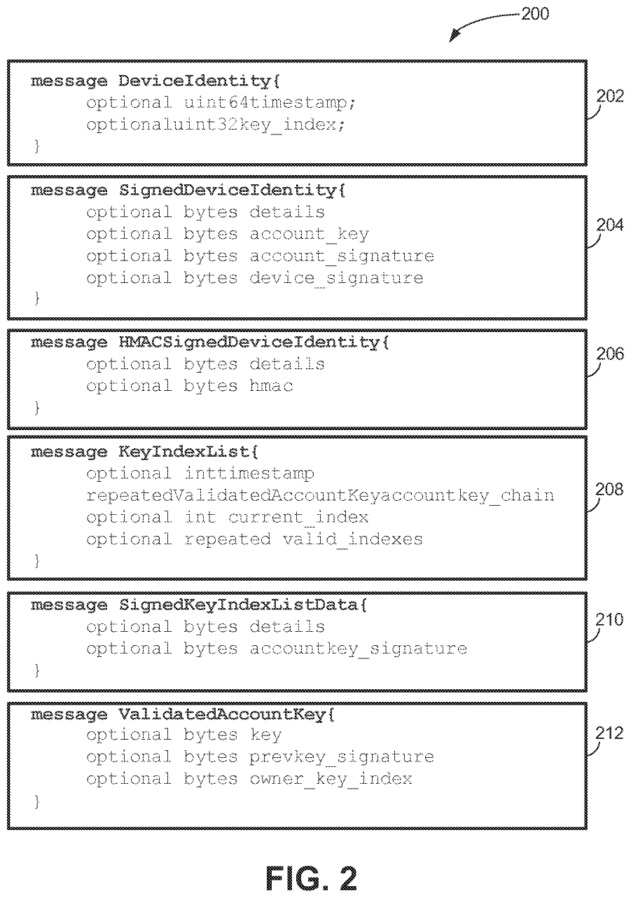

FIG. 2 illustrates an example data model 200 for configuring signing authority between multiple user devices, according to certain aspects of the disclosure. In this example, data model 200 may facilitate one or more of adding initial and subsequent devices, signing communications with device and account identity, removing devices, and/or verifying communications. Communication may occur between devices on a communication network and/or between devices and an authorization server. The authorization server may comprise an encrypted server within an end-to-end encrypted messaging system.

According to certain aspects, the data model 200 may be implemented in adding devices. For example, adding a first device to a user account, where no other device currently exists, may include generating a public-private keypair (e.g., “accountkey”). In this example, an EdDSA signature scheme may be utilized:

(accountkeyₚᵣᵢᵥ,accountkey_{pub})←gen_ed25519( )

Adding a first device to a user account, where no other device currently exists, may include generating a key index list data (e.g., “KeyIndexListData”). Generating the key index list data may include setting a timestamp to the current time on the device. Generating the key index list data may include generating a validated account key (e.g., “ValidatedAccountKey”) (see 212), including setting:

key to accountkey_{pub};

prevkey_signature to empty; and

owner_key_index to key_index of device 1.

Generating the key index list data may include appending the newly created validated account key (e.g., ValidatedAccountKey) to an account keychain “accountkey_chain,” which may, only contain one element). Generating the key index list data may include setting a current index (e.g., “current_index”) to 1 and appending the current index to a valid indexes list (e.g., “valid_indexes”). Generating the key index list data may include generating signed key index list data (e.g., “SignedKeyIndexListData”) (see 210), including encoding the previously generated key index list data (e.g., KeyIndexListData) into details and signing details with the public-private keypair (e.g., “accountkey”):

accountkey_signature←pkSign(accountkeyₚᵣᵢᵥ,details)

Generating the key index list data may include uploading the signed key index list data (e.g., “SignedKeyIndexListData”) to the authorization server.

Adding a first device to a user account, where no other device currently exists, may include generating a device identity (e.g., “DeviceIdentity”) (see 202).

When other devices do currently exist, the data model 200 may be implemented in adding devices. By way of non-limiting illustration, Device A may be an already registered device on the user account and Device B may be a subsequent device that is in the process of onboarding. Adding Device B to the user account may include Device B displaying a QR code containing the following information:

id_pubkey_{b}; and

secret_key_{b} (Used to verify that Device A did in fact sign in Device B).

Adding Device B to the user account may include Device A scanning this QR code and retrieving the above data through the secure QR code channel. Other channels may be used to transmit this data, including those employing end-to-end encryption (“e2ee”), for example a pairing code.

Adding Device B to the user account may include Device A that the device has the latest key index list data (e.g., “KeyIndexListData”) and account key (e.g., “AccountKey”). Adding Device B to the user account may include Device A generating a key index list (e.g., “KeyIndexList”) (see 208) including setting the timestamp to the current time on the device, setting the current index (e.g., to KeyIndexList.current_index+1), and appending the current index (e.g., “current_index”) to the valid indexes list (e.g., “valid_indexes”). Adding Device B to the user account may include Device A generating a signed key index list (e.g., “SignedKeyIndexList”) including encoding the previously generated key index list (e.g., “KeyIndexList”) (see 208) into details and signing details with the account key (e.g., accountkey):

accountkey_signature←pkSign(accountkeyₚᵣᵢᵥ,details)

Adding Device B to the user account may include Device A uploading the signed key index list (e.g., “SignedKeyIndexList”) to the authorization server. Adding Device B to the user account may include Device A generating a device identity (e.g., “DeviceIdentity”) (see 202) including setting the timestamp to the current time and setting a key index (e.g., setting “key_index” to “current_index” in “KeyIndexList”). Adding Device B to the user account may include Device A generating a signed device identity (e.g., “SignedDeviceIdentity”) including encoding the device identity (e.g., “DeviceIdentity”) (see 202) as details in a signed device identity (e.g., “SignedDeviceIdentity”) protocol buffer and signing details with the account key (e.g., “accountkey”):

accountkey_signature←pkSign(accountkeyₚᵣᵢᵥ,details)

Adding Device B to the user account may include Device A generating a hash-based message authentication code (“HMAC”) from a secret key (e.g., “secret_key_{b}”), and filling in an HMAC signed device identity (e.g., “HMACSignedDeviceIdentity) (see 206) protocol buffer. Adding Device B to the user account may include Device A sending the HMAC signed device identity (e.g., “HMACSignedDeviceIdentity) payload to Device B through an insecure channel.

Adding Device B to the user account may include Device B verifying the HMAC with the stored secret key (e.g., “secret_key_{b}”). Adding Device B to the user account may include Device B signing the details of the signed device identity (e.g., “SignedDeviceIdentity) (see 204) alongside some additional data to generate a device signature (e.g., “device signature”):

device signature←pkSign (id_priv_{b},details+accountkey_{pub}+id_pub_{b})

Adding Device B to the user account may include Device B adding the above generated signature to the signed device identity (e.g., “SignedDeviceIdentity”) (see 204), and uploading to the authorization server.

Adding Device B to the user account may include Device A sending Device B the private account key (e.g., “accountkeyₚᵣᵢᵥ”) through the now securely setup signal channel. As an option to add another level of protection, the private account key (e.g., “accountkeyₚᵣᵢᵥ”) may be encrypted with the secret key (e.g., “secret_key_{b}”) that was exchanged through the QR code. At this point, Device B may have the necessary secrets to onboard other devices.

In certain cases, a device may have enough key material to be able to cryptographically verify itself to other devices in the communication platform. The following two cases are examples where the data model 200 may be implemented in device identity signing. In a first example, the very first device is registered to a user's account. In a second example, a DeviceIdentity (202) is regenerated due to another device being removed from the account. This does not, however, preclude other devices from showing security notifications.

Generating a device identity (e.g., DeviceIdentity) (see 202) may include setting a timestamp to the current time and setting a key index (e.g., setting key_index to current_index in KeyIndexList (208), if not already set). If updating an existing device identity, the key_index may not be updated.

Generating a signed device identity (e.g., SignedDeviceIdentity) (see 204) may include encoding the device identity as details in the signed device identity protocol buffer, and signing the details with the latest account key (e.g., accountkey):

accountkey_signature←pkSign(accountkeyₚᵣᵢᵥ,details)

Generating a signed device identity may include signing the details of the signed device identity alongside additional data with the device's identity key to generate a device signature (e.g., device signature):

device signature←pkSign(id_priv_{self},details+accountkey_{pub}+id_pub_{self})

For devices that are updating an existing device identity, existing sessions should be marked to receive this new device identity.

Since a secret may be shared across all trusted devices, device removals become more complicated. The device initiating the remove may need to be up to date on the necessary cryptographic keys for secure communication.

According to certain examples, a device initiating a device removal may have a process to follow utilizing the data model 200. The device may generate a new account key pair (e.g., a new “accountkey”). In this example, an EdDSA signature scheme may be utilized:

(accountkey_priv_{new},accountkey_pub_{new})←gen_ed25519( ).

Generating a validated account key (e.g., ValidatedAccountKey) (see 212) protocol buffer may include signing the new account key with the old account key:

accountkey_signature_{new}←pkSign(accountkey_priv_{old},accountkey_pub_{new}).

Generating a validated account key may include setting the previous signature (e.g., prev_signature) to the new account key signature (e.g., accountkey_signature_{new}). Generating a validated account key may include setting the new public account key (e.g., accountkey_pub_{new}) as the new key and setting the owner key index to the key index of the device.

Updating the key index list (e.g., KeyIndexList) (see 208) may include removing the key index (e.g., key_index) of the removed device from the list of valid indexes (e.g., valid indexes). Updating the key index list may include appending the validated account key (e.g., ValidatedAccountKey) (see 212) into the account key chain (e.g., accountkey_chain). In some instances, the earliest link in the chain may be removed in the case of a protocol defined limit on the chain. Updating the key index list may include updating the timestamp to the current device time.

Generating a signed key index list may include encoding the key index list into details and signing the details with the new account key:

accountkey_signature←pkSign(accountkey_priv_{new},details)

The signed key index list may then be uploaded to the authorization server. An upload failure may suggest that the client is on an old account key. To proceed with such a device, it may be required to have the latest account key.

The new account key pair (e.g., accountkey_priv_{new},accountkey_pub_{new}) may be sent to the other devices in the account. Each device may update their own device identity (e.g., DeviceIdentity) (see 202) as soon as they are online (including the device initiating the remove), via the process described above.

According to additional examples, instead of rotating the account key on every removal, the account key may be rotated only after a predetermined amount of time (e.g., 14 days, etc.) has elapsed. This option can allow the protocol to keep the chains relatively small as well as minimize the likelihood of security notifications. According to additional aspects, periodic rotations may also be performed in order to limit lengths of chains when many removals may occur, as well as to strengthen security through using keys for shorter periods of time.

In some cases, the authorization server may have the ability to remove devices without user action or based on a user configuration. An example includes expiring certain devices after they are inactive for a threshold amount of time. In these circumstances, a device may perform the above-described removal process steps. A device may fetch all device identities and the key index list (e.g., KeyIndexList) (see 208) and may verify whether necessary modifications have been made. If the modifications are verified, the device may not update. This could happen, for example, if another device engaged in the process first. The operation may be atomic.

By way of example, assume four devices are authorized on a user account. Device 4 becomes lost or compromised. Device 1 may go through the process described to remove Device 4. If compromised Device 4 is used to add another (malicious) device to the account, this device may be visible to the original user on their uncompromised device(s), and available for removal. If compromised Device 4 is used to add another (malicious) device to the account, and the authorization servers are compromised to prevent the display of the additional device, then, when the user performs an action which would result in updating the account key (for example, removing Device 4), the additional device may not receive the account key update and may no longer have any authority on the user account. In addition to these precautions, the communications network may notify all of a user's devices whenever a new device is added to the account.

Device verification may be accomplished by receiving a message including a device identity (e.g., DeviceIdentity) (see 202) when no public account key (e.g., accountkey_{pub}) is saved for the message sender. Device verification may include decoding the protocol buffer and the details. Device verification may include verifying the account key signature (e.g., accountkey_signature) and aborting if this step fails. Device verification may include verifying the device signature (e.g., device signature) and aborting if this fails. Device verification may include saving the public account key (e.g., accountkey_{pub}).

Device verification may be accomplished by receiving a message including a device identity (e.g., DeviceIdentity) (see 202) when the public account key (accountkey_{pub}) is saved for the message sender. If the saved public account key is equal to the public account key in the received device identity, the above steps may be followed to finish verification. If the public account keys are not equal, the device may check the latest key index list (e.g., KeyIndexList) (see 208), to determine if the saved public account key is part of the account key chain. If the saved public account key is not part of the account key chain, a security notification may be generated. Verification may be completed by following the above described steps for receiving a message including a device identity when no public account key is saved for the message sender.

Device verification may be accomplished by receiving a message including a device identity (e.g., DeviceIdentity) (see 202) for an already verified device. When account keys are rotated, already verified devices may re-generate their device identities with the rotated account key. This means a message from a device that already has a session may contain a device identity node. In this case, refer to the steps above for verifying a device when receiving a message including a device identity when the public account key is saved for the message sender.

Device verification may be accomplished by receiving an updated key index list (e.g., KeyIndexList) (see 208) with a new account key. Device verification may include invalidating (but not removing) all device identities that are using the old account key. The next message received from the invalidated devices may contain an updated device identity. In some examples, offline messages may be processed with priority before invalidation of the device. Once the next message is received, follow the steps described above for device verification when receiving a message including a device identity for an already verified device.

For any device on a user account to perform device removals of other devices, it may need to have the latest account key and key index list (e.g., KeyIndexList) (see 208). As long as a device is an authorized device associated with the user account, it may receive updates for the latest account keys. According to some examples, a device may ensure that any messages queued while offline are completely processed prior to adding or removing devices. When account key update messages are sent through a one-to-one channel between devices, it may be possible that the message gets stuck, lost or pruned while offline. In such a circumstance, the device may figure this out by matching the current account public key in the key index list and compare it with the one stored.

The disclosed system(s) address a problem in traditional user authentication techniques tied to computer technology, namely, the technical problem of establishing and maintaining trust between multiple user devices on a communication platform. The disclosed system solves this technical problem by providing a solution also rooted in computer technology, namely, by providing equal signing authority between multiple devices of a single user in an end-to-end encrypted messaging system. The disclosed subject technology further provides improvements to the functioning of the computer itself because it improves processing and efficiency in user authentication.

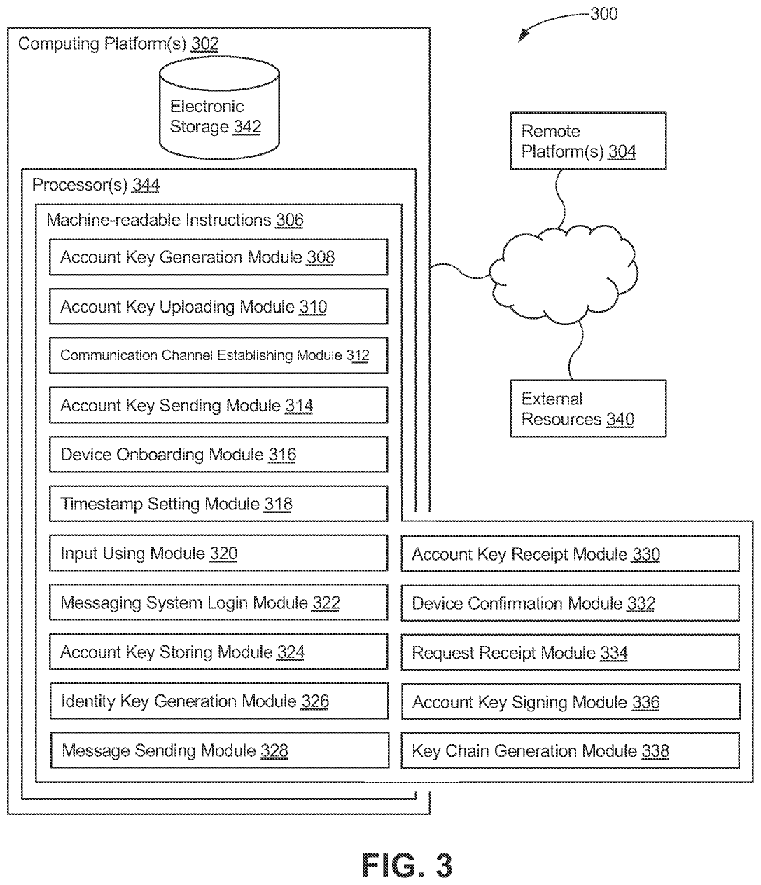

FIG. 3 illustrates a system 300 configured for user authentication, according to certain aspects of the disclosure. In some implementations, system 300 may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304.

Computing platform(s) 302 may be configured by machine-readable instructions 306. Machine-readable instructions 306 may include one or more instruction modules. The instruction modules may include computer program modules. The instruction modules may include one or more of account key generation module 308, account key uploading module 310, communication channel establishing module 312, account key sending module 314, device onboarding module 316, timestamp setting module 318, input using module 320, messaging system login module 322, account key storing module 324, identity key generation module 326, message sending module 328, account key receipt module 330, device confirmation module 332, request receipt module 334, account key signing module 336, key chain generation module 338, and/or other instruction modules.

Account key generation module 308 may be configured to generate an account key comprising a public account key and a private account key for onboarding a first user device of a first user to the end-to-end encrypted messaging system. The account key may be generated locally on the first user device.

Account key uploading module 310 may be configured to upload the public account key to an encrypted server of the end-to-end encrypted messaging system.

Communication channel establishing module 312 may be configured to, in response to a request to onboard a second user device to the end-to-end encrypted messaging system, establish a secure communication channel between the second user device and the first user device. The second user device may be different from the first user device. The secure communication channel may be established through the first user device receiving an input originating from the second user device. The secure communication channel may be established through the second user device receiving an input originating from the first user device. By way of non-limiting example, the input may include one or more of a QR code, a pin code, or a passcode. The input may include data comprising one or more of a secret key and a public identity key for the second user device. In some examples, this data is sufficient to allow the first and second user devices to establish a secure communication channel between the devices.

Account key sending module 314 may be configured to send a copy of the private account key to the second user device from the first user device through the secure communication channel.

Device onboarding module 316 may be configured to onboard a third user device to the end-to-end encrypted messaging system through either the first user device or the second user device. A security notification may be generated to authenticate a new device of the first user. The security notification may be distributed to onboarded devices of the first user.

Timestamp setting module 318 may be configured to set a timestamp of the encrypted server to a current time on the first user device.

Input using module 320 may be configured to use the input to establish the secure communication channel between the second user device and the first user device.

Messaging system login module 322 may be configured to, prior to generating the account key, logging into the end-to-end encrypted messaging system through the first user device.

Account key storing module 324 may be configured to store the private account key locally on the first user device.

Account key storing module 324 may be configured to store the copy of the private account key locally on the second user device.

Identity key generation module 326 may be configured to, for each user device, generate an identity key comprising a public identity key and a private identity key. Each public identity key may be uploaded to the encrypted server. Each private identity key may be stored locally on each device.

Message sending module 328 may be configured to send a message, via the second device, to a second user, the message comprising a public identity key of the second device. Sending the message may include signing the message with the public account key of the first user.

Account key receipt module 330 may be configured to receive, at a device of the second user, the public account key stored on the encrypted server.

Device confirmation module 332 may be configured to confirm, through the device of the second user, that the second device is legitimately associated with the public identity key of the second device by comparing the public account key received from the encrypted server with the public account key utilized to sign the message.

Request receipt module 334 may be configured to receive a request to remove a device from a first user account.

Account key generation module 308 may be configured to generate, based on the request, a new account key to replace the account key.

Account key sending module 314 may be configured to distribute the new account key to other devices of the first user that were not removed. The distributing of the new account key may be done over a secure communication channel.

Account key signing module 336 may be configured to sign the new account key with the account key.

Identity key generation module 326 may be configured to generate an identity key comprising a public identity key and a private identity key.

Account key signing module 336 may be configured to sign, with the new account key, the public identity key.

Account key uploading module 310 may be configured to upload to the encrypted server the signed public identity key.

Key chain generation module 338 may be configured to generate a key chain comprising at least the previous account key and the new account key. The key chain may extend to contain multiple previous versions of the account key. In some examples, the key chain may be truncated or limited after a predetermined number of account keys are added.

Account key generation module 308 may be configured to generate, after the occurrence of an event, a new account key (e.g., a new private account key) to replace the account key.

Account key sending module 314 may be configured to distribute the new account key to other devices of the first user.

Account key signing module 336 may be configured to sign the new account key with the account key. The event may include the passage of a predetermined amount of time.

In some implementations, computing platform(s) 302, remote platform(s) 304, and/or external resources 340 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 302, remote platform(s) 304, and/or external resources 340 may be operatively linked via some other communication media.

A given remote platform 304 may include one or more processors configured to execute computer program modules. The computer program modules may be configured to enable an expert or user associated with the given remote platform 304 to interface with system 300 and/or external resources 340, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

External resources 340 may include sources of information outside of system 300, external entities participating with system 300, and/or other resources. In some implementations, some or all of the functionality attributed herein to external resources 340 may be provided by resources included in system 300.

Computing platform(s) 302 may include electronic storage 342, one or more processors 344, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 342 may comprise non-transitory storage media that electronically stores information. The electronic storage media of electronic storage 342 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 342 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 342 may include one or more virtual storage resources (e.g., cloud storage, a virtual private network, and/or other virtual storage resources). Electronic storage 342 may store software algorithms, information determined by processor(s) 344, information received from computing platform(s) 302, information received from remote platform(s) 304, and/or other information that enables computing platform(s) 302 to function as described herein.

Processor(s) 344 may be configured to provide information processing capabilities in computing platform(s) 302. As such, processor(s) 344 may include one or more of a digital processor, an analog processor, a digital circuit designed to process information, an analog circuit designed to process information, a state machine, and/or other mechanisms for electronically processing information. Although processor(s) 344 is shown in FIG. 3 as a single entity, this is for illustrative purposes only. In some implementations, processor(s) 344 may include a plurality of processing units. These processing units may be physically located within the same device, or processor(s) 344 may represent processing functionality of a plurality of devices operating in coordination. Processor(s) 344 may be configured to execute modules 308, 310, 312, 314, 316, 318, 320, 322, 324, 326, 328, 330, 332, 334, 336, and/or 338, and/or other modules. Processor(s) 344 may be configured to execute modules 308, 310, 312, 314, 316, 318, 320, 322, 324, 326, 328, 330, 332, 334, 336, and/or 338, and/or other modules by software; hardware; firmware; some combination of software, hardware, and/or firmware; and/or other mechanisms for configuring processing capabilities on processor(s) 344. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 308, 310, 312, 314, 316, 318, 320, 322, 324, 326, 328, 330, 332, 334, 336, and/or 338 are illustrated in FIG. 3 as being implemented within a single processing unit, in implementations in which processor(s) 344 includes multiple processing units, one or more of modules 308, 310, 312, 314, 316, 318, 320, 322, 324, 326, 328, 330, 332, 334, 336, and/or 338 may be implemented remotely from the other modules. The description of the functionality provided by the different modules 308, 310, 312, 314, 316, 318, 320, 322, 324, 326, 328, 330, 332, 334, 336, and/or 338 described below is for illustrative purposes, and is not intended to be limiting, as any of modules 308, 310, 312, 314, 316, 318, 320, 322, 324, 326, 328, 330, 332, 334, 336, and/or 338 may provide more or less functionality than is described. For example, one or more of modules 308, 310, 312, 314, 316, 318, 320, 322, 324, 326, 328, 330, 332, 334, 336, and/or 338 may be eliminated, and some or all of its functionality may be provided by other ones of modules 308, 310, 312, 314, 316, 318, 320, 322, 324, 326, 328, 330, 332, 334, 336, and/or 338. As another example, processor(s) 344 may be configured to execute one or more additional modules that may perform some or all of the functionality attributed below to one of modules 308, 310, 312, 314, 316, 318, 320, 322, 324, 326, 328, 330, 332, 334, 336, and/or 338.

In particular embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular embodiments, privacy settings may be based on one or more nodes or edges of a social graph. A privacy setting may be specified for one or more edges or edge-types of the social graph, or with respect to one or more nodes, or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system. The object may be associated with a concept node connected to a user node of the first user by an edge. The first user may specify privacy settings that apply to a particular edge connecting to the concept node of the object, or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers may be authorization/privacy servers for enforcing privacy settings. In response to a request from a user (or other entity) for a particular object stored in a data store, the social-networking system may send a request to the data store for the object. The request may identify the user associated with the request and the object may be sent only to the user (or a client system of the user) if the authorization server determines that the user is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system may access such information in order to provide a particular function or service to the first user, without the social-networking system having access to that information for any other purposes. Before accessing, storing, or using such objects or information, the social-networking system may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system.

In particular embodiments, a user may specify whether particular types of objects or information associated with the first user may be accessed, stored, or used by the social-networking system. As an example and not by way of limitation, the first user may specify that images sent by the first user through the social-networking system may not be stored by the social-networking system. As another example and not by way of limitation, a first user may specify that messages sent from the first user to a particular second user may not be stored by the social-networking system. As yet another example and not by way of limitation, a first user may specify that all objects sent via a particular application may be saved by the social-networking system.

In particular embodiments, privacy settings may allow a first user to specify whether particular objects or information associated with the first user may be accessed from particular client systems or third-party systems. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system may provide default privacy settings with respect to each device, system, or application, and/or the first user may be prompted to specify a particular privacy setting for each context. As an example and not by way of limitation, the first user may utilize a location-services feature of the social-networking system to provide recommendations for restaurants or other places in proximity to the user. The first user's default privacy settings may specify that the social-networking system may use location information provided from a client device of the first user to provide the location-based services, but that the social-networking system may not store the location information of the first user or provide it to any third-party system. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The social-networking system may determine that this privacy setting also applies to the first image and make the first image visible only to the first user group. In particular embodiments, the change in privacy settings may take effect only going forward. Continuing the example above, if the first user changes privacy settings and then shares a second image, the second image may be visible only to the first user group, but the first image may remain visible to all users. In particular embodiments, in response to a user action to change a privacy setting, the social-networking system may further prompt the user to indicate whether the user wants to apply the changes to the privacy setting retroactively. In particular embodiments, a user change to privacy settings may be a one-off change specific to one object. In particular embodiments, a user change to privacy may be a global change for all objects associated with the user.

In particular embodiments, the social-networking system may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular embodiments, upon determining that a trigger action has occurred, the social-networking system may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular embodiments, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the social-networking system may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the social-networking system may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular embodiments, a user may need to provide verification of a privacy setting on a periodic basis. A prompt or reminder may be periodically sent to the user based either on time elapsed or a number of user actions. As an example and not by way of limitation, the social-networking system may send a reminder to the user to confirm his or her privacy settings every six months or after every ten photo posts. In particular embodiments, privacy settings may also allow users to control access to the objects or information on a per-request basis. As an example and not by way of limitation, the social-networking system may notify the user whenever a third-party system attempts to access information associated with the user, and require the user to provide verification that access should be allowed before proceeding.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

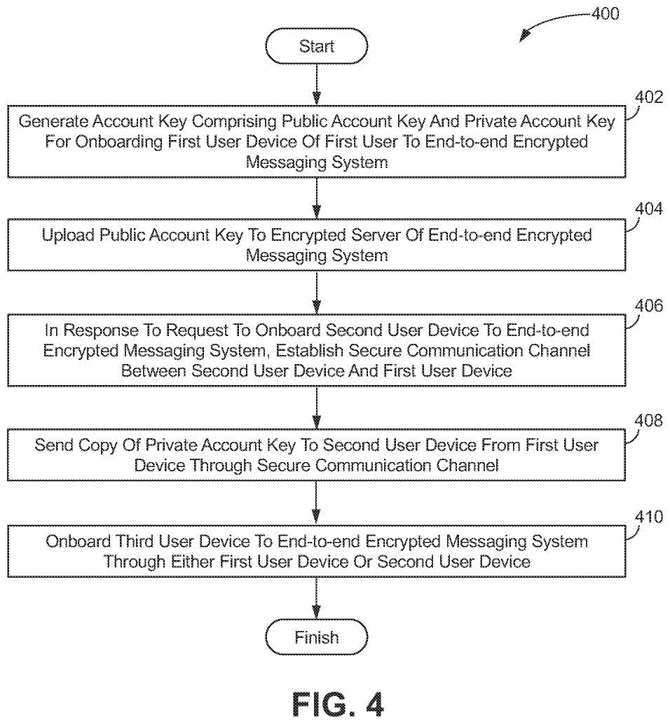

FIG. 4 illustrates an example flow diagram (e.g., process 400) for user authentication, according to certain aspects of the disclosure. For explanatory purposes, the example process 400 is described herein with reference to FIGS. 1-3. Further for explanatory purposes, the steps of the example process 400 are described herein as occurring in serial, or linearly. However, multiple instances of the example process 400 may occur in parallel. For purposes of explanation of the subject technology, the process 400 will be discussed in reference to FIGS. 1-3.

At a step 402, the process 400 may include generating an account key comprising a public account key and a private account key for onboarding a first user device of a first user to the end-to-end encrypted messaging system. At a step 404, the process 400 may include uploading the public account key to an encrypted server of the end-to-end encrypted messaging system. At a step 406, the process 400 may include, in response to a request to onboard a second user device to the end-to-end encrypted messaging system, establishing a secure communication channel between the second user device and the first user device. At a step 408, the process 400 may include sending a copy of the private account key to the second user device from the first user device through the secure communication channel. At a step 410, the process 400 may include onboarding a third user device to the end-to-end encrypted messaging system through either the first user device or the second user device.

For example, as described above in relation to FIGS. 1-3, at a step 402, the process 400 may include generating an account key comprising a public account key and a private account key for onboarding a first user device of a first user to the end-to-end encrypted messaging system, through account key generation module 308. At a step 404, the process 400 may include uploading the public account key to an encrypted server of the end-to-end encrypted messaging system, through account key uploading module 310. At a step 406, the process 400 may include, in response to a request to onboard a second user device to the end-to-end encrypted messaging system, establishing a secure communication channel between the second user device and the first user device, through communication channel establishing module 312. At a step 408, the process 400 may include sending a copy of the private account key to the second user device from the first user device through the secure communication channel, through account key sending module 314. At a step 410, the process 400 may include onboarding a third user device to the end-to-end encrypted messaging system through either the first user device or the second user device, through device onboarding module 316.

According to an aspect, the account key is generated locally on the first user device.

According to an aspect, the process 400 further includes setting a timestamp of the encrypted server to a current time on the first user device.

According to an aspect, the secure communication channel is established through the first user device receiving an input originating from the second user device.

According to an aspect, the input comprises one of a QR code, a pin code, or a passcode.

According to an aspect, the process 400 further includes using the input to establish the secure communication channel between the second user device and the first user device.

According to an aspect, the input includes data comprising one or more of a secret key and a public identity key for the second user device.

According to an aspect, the secure communication channel is established through the second user device receiving an input originating from the first user device.

According to an aspect, the second user device is different from the first user device.

According to an aspect, the process 400 further includes, prior to generating the account key, logging into the end-to-end encrypted messaging system through the first user device.

According to an aspect, the process 400 further includes storing the private account key locally on the first user device.

According to an aspect, the process 400 further includes storing the copy of the private account key locally on the second user device.

According to an aspect, the process 400 further includes, for each user device, generating an identity key comprising a public identity key and a private identity key.

According to an aspect, each public identity key is uploaded to the encrypted server, and each private identity key is stored locally on each device.

According to an aspect, the process 400 further includes sending a message, via the second device, to a second user, the message comprising a public identity key of the second device, wherein the sending further comprises signing the message with the public account key of the first user.

According to an aspect, the process 400 further includes receiving, at a device of the second user, the public account key stored on the encrypted server.

According to an aspect, the process 400 further includes confirming, through the device of the second user, that the second device is legitimately associated with the public identity key of the second device by comparing the public account key received from the encrypted server with the public account key utilized to sign the message.

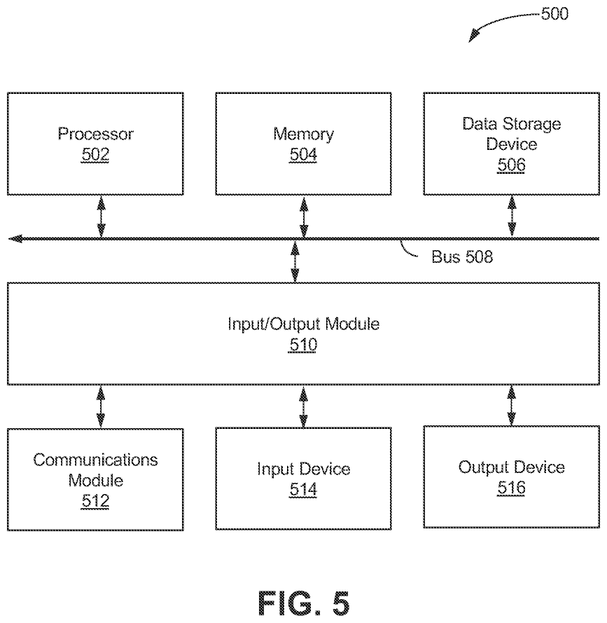

FIG. 5 is a block diagram illustrating an exemplary computer system 500 with which aspects of the subject technology can be implemented. In certain aspects, the computer system 500 may be implemented using hardware or a combination of software and hardware, either in a dedicated server, integrated into another entity, or distributed across multiple entities.

Computer system 500 (e.g., server and/or client) includes a bus 508 or other communication mechanism for communicating information, and a processor 502 coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer-readable medium for execution by, or to control the operation of, the computer system 500, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, the input/output module 510 is configured to connect to a plurality of devices, such as an input device 514 and/or an output device 516. Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 516 include display devices such as an LCD (liquid crystal display) monitor, for displaying information to the user.

According to one aspect of the present disclosure, the above-described gaming systems can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in the main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 500 reads game data and provides a game, information may be read from the game data and stored in a memory device, such as the memory 504. Additionally, data from the memory 504 servers accessed via a network the bus 508, or the data storage 506 may be read and loaded into the memory 504. Although data is described as being found in the memory 504, it will be understood that data does not have to be stored in the memory 504 and may be stored in other memory accessible to the processor 502 or distributed among several media, such as the data storage 506.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for providing equal signing authority between multiple devices of a single user in an end-to-end encrypted messaging system, comprising:
generating an account key comprising a public account key and a private account key for onboarding a first user device of a first user to the end-to-end encrypted messaging system;
uploading the public account key to an encrypted server of the end-to-end encrypted messaging system;
in response to a request to onboard a second user device to the end-to-end encrypted messaging system, establishing a secure communication channel between the second user device and the first user device;
sending a copy of the private account key to the second user device from the first user device through the secure communication channel; and
onboarding a third user device to the end-to-end encrypted messaging system through either the first user device or the second user device.

2. The computer-implemented method of claim 1, wherein the account key is generated locally on the first user device.

3. The computer-implemented method of claim 1, further comprising:
setting a timestamp of the encrypted server to a current time on the first user device.

4. The computer-implemented method of claim 1, wherein the secure communication channel is established through the first user device receiving an input originating from the second user device.

5. The computer-implemented method of claim 4, wherein the input comprises one of a QR code, a pin code, or a passcode.

6. The computer-implemented method of claim 4, further comprising:
using the input to establish the secure communication channel between the second user device and the first user device.

7. The computer-implemented method of claim 4, wherein the input includes data comprising one or more of a secret key and a public identity key for the second user device.

8. The computer-implemented method of claim 1, wherein the secure communication channel is established through the second user device receiving an input originating from the first user device.

9. The computer-implemented method of claim 1, wherein the second user device is different from the first user device.

10. The computer-implemented method of claim 1, further comprising:
prior to generating the account key, logging into the end-to-end encrypted messaging system through the first user device.

11. A system configured for providing equal signing authority between multiple devices of a single user in an end-to-end encrypted messaging system, comprising:
one or more hardware processors configured by machine-readable instructions to:
generate an account key comprising a public account key and a private account key for onboarding a first user device of a first user to the end-to-end encrypted messaging system;
upload the public account key to an encrypted server of the end-to-end encrypted messaging system;
in response to a request to onboard a second user device to the end-to-end encrypted messaging system, establish a secure communication channel between the second user device and the first user device;
send a copy of the private account key to the second user device from the first user device through the secure communication channel;
onboard a third user device to the end-to-end encrypted messaging system through either the first user device or the second user device;
generating, after occurrence of an event, a new account key to replace the account key;
distributing the new account key to other devices of the first user; and
signing the new account key with the account key.

12. The system of claim 11, wherein the account key is generated locally on the first user device.

13. The system of claim 11, wherein the one or more hardware processors are further configured by machine-readable instructions to:
set a timestamp of the encrypted server to a current time on the first user device.

14. The system of claim 11, wherein the secure communication channel is established through the first user device receiving an input originating from the second user device.

15. The system of claim 14, wherein the input comprises one of a QR code, a pin code, or a passcode.

16. The system of claim 14, wherein the one or more hardware processors are further configured by machine-readable instructions to:
use the input to establish the secure communication channel between the second user device and the first user device.

17. The system of claim 14, wherein the input includes data comprising one or more of a secret key and a public identity key for the second user device.

18. The system of claim 11, wherein the secure communication channel is established through the second user device receiving an input originating from the first user device.

19. The system of claim 11, wherein the second user device is different from the first user device, and wherein the one or more hardware processors are further configured by machine-readable instructions to:
prior to generating the account key, log into the end-to-end encrypted messaging system through the first user device.

20. A non-transient computer-readable storage medium having instructions embodied thereon, the instructions being executable by one or more processors to perform a computer-implemented method for providing equal signing authority between multiple devices of a single user in an end-to-end encrypted messaging system, the method comprising:
generating an account key comprising a public account key and a private account key for onboarding a first user device of a first user to the end-to-end encrypted messaging system;
uploading the public account key to an encrypted server of the end-to-end encrypted messaging system;
in response to a request to onboard a second user device to the end-to-end encrypted messaging system, establishing a secure communication channel between the second user device and the first user device;
sending a copy of the private account key to the second user device from the first user device through the secure communication channel;
onboarding a third user device to the end-to-end encrypted messaging system through either the first user device or the second user device;
in response to a request to remove the second user device, removing the second user device from a key index list;
generating a new account key comprising a new public account key and a new private account key; and
sending a copy of the account key to the first user device and the third user device.
